(19) United States
(12) Patent Application Publication
(10) Pub. No.: US 2026/0313679 A1
(43) Pub. Date: Oct. 8, 2026

(54) METHOD FOR DETERMINING INFORMATION RELATED TO PERIODIC LOW-LATENCY SERVICE

(71) Applicant: Beijing Xiaomi Mobile Software Co., Ltd., Beijing (CN)

(72) Inventor: Xiandong DONG, Beijing (CN)

(21) Appl. No.: 19/461,505

(22) Filed: Jan. 27, 2026

Related U.S. Application Data
(63) Continuation of application No. 18/252,010, filed on Nov. 6, 2020, now Pat. No. 12,574,955.

(51) Int. Cl. H04W 72/543; H04W 72/04

(52) U.S. Cl. CPC H04W 72/543; H04W 72/04

(57) ABSTRACT

A communication method includes: determining a first message frame, where the first message frame includes information related to a periodic low-latency service, and the information related to the periodic low-latency service is configured to indicate the periodic low-latency service sent by a station; and sending the first message frame.

### CROSS REFERENCE TO RELATED APPLICATION

The present application is a continuation application of U.S. patent application Ser. No. 18/252,010, filed on May 5, 2023, which is a U.S. National Stage of International Application No. PCT/CN2020/127185, filed on Nov. 6, 2020, the entire contents of each of which are incorporated herein by reference for all purposes.

### BACKGROUND

The Institute of Electrical and Electronics Engineers (IEEE) established the Task Group (TG) IEEE 802.11be to study the next-generation Wi-Fi technology (IEEE 802.11a/b/g/n/ac). The scope of the study includes 320 MHz bandwidth transmission, multi-band aggregation and cooperation, and the like. These technologies are expected to improve the rate and throughput by at least four times relative to an existing IEEE 802.11ax standard, and their main application scenarios are video transmission, augmented reality (AR), virtual reality (VR), etc.

The multi-band aggregation and cooperation refer to communication between devices over the 2.4 GHz, 5.8 GHz, and 6-7 GHz frequency bands at the same time. A new media access control (MAC) mechanism needs to be defined to manage the communication between the devices over a plurality of frequency bands at the same time. In addition, low-latency transmission is expected to be supported in IEEE 802.11be.

In discussions of the IEEE 802.11be standard, the maximum bandwidth that will be supported is 320 MHz (160 MHz+160 MHz). In addition, 240 MHz (160 MHz+80 MHz) and the bandwidth supported in the IEEE 802.11ax standard may also be supported.

In the IEEE 802.11be standard, transmission of time-sensitive network (TSN) data is supported, which generally requires a latency of less than or equal to 1 ms; or transmission of data such as AR/VR is supported, which generally requires a latency between 1 ms and 10 ms. In addition, transmission of data such as interactive video or autonomous-driving control generally requires a latency between 10 ms and 50 ms.

### SUMMARY

All aspects of the disclosure at least solve the above problems and/or defects. Various examples of the disclosure provide the following technical solutions.

According to an example of the disclosure, a communication method is provided. The communication method may be performed by a station and may include: determining a first message frame, where the first message frame includes information related to a periodic low-latency service, and the information related to the periodic low-latency service is configured to indicate the periodic low-latency service sent by the station; and sending the first message frame.

According to an example of the disclosure, a communication method is provided. The communication method may be performed by an access point and may include: receiving a first message frame from a station, where the first message frame includes information related to a periodic low-latency service, and the information related to the periodic low-latency service is configured to indicate the periodic low-latency service sent by the station; and determining a third message frame based on the information related to the periodic low-latency service, where the third message frame is configured to allocate transmission resources to the station periodically.

According to an example of the disclosure, an electronic device is provided. The electronic device includes: a memory that stores instructions; and one or more processors; where the instructions, when collectively executed by one or more processors, cause the electronic device to: determine a first message frame, where the first message frame includes information related to a periodic low-latency service, and the information related to the periodic low-latency service is configured to indicate the periodic low-latency service sent by the station; and send the first message frame.

According to an example of the disclosure, a non-transitory computer-readable storage medium is provided. The non-transitory computer-readable storage medium stores instructions, where the instructions, when executed by a processor, cause the processor to perform the communication method as described above.

### BRIEF DESCRIPTION OF THE DRAWINGS

By a detailed description of examples of the disclosure with reference to accompanying drawings, the above and other features of examples of the disclosure will be more apparent.

FIG. 1 shows an example schematic diagram of a wireless communication scenario according to an example of the disclosure.

FIG. 2 shows a flowchart of a communication method according to an example of the disclosure.

FIG. 3 shows a flowchart of another communication method according to an example of the disclosure.

FIG. 4 shows a flowchart of communication between a station and an access point according to an example of the disclosure.

FIG. 5 shows a block diagram of a communication device according to an example of the disclosure.

FIG. 6 shows a block diagram of another communication device according to an example of the disclosure.

### DETAILED DESCRIPTION

The following description, with reference to accompanying drawings, is provided to aid in a full understanding of various examples of the disclosure as limited by the appended claims and their equivalents. Various examples of the disclosure include various specific details, but these specific details are merely considered to be examples. In addition, for clarity and conciseness, a description of well-known technologies, functions, and constructions may be omitted.

Terms and words used in the disclosure are not limited to written meanings, but are merely used by the inventor to enable a clear and consistent understanding of the disclosure. Accordingly, to those skilled in the art, the description of the various examples of the disclosure is provided merely for an illustrative purpose, but not for a purpose of limitation.

It is to be understood that, unless a context clearly indicates otherwise, singular forms “one”, “a”, “said”, and “the” used here may also include plural forms. It is to be further understood that an expression “include” as used in the disclosure refers to the presence of described features, integers, steps, operations, elements, and/or components, but does not exclude the presence or addition of one or more other features, integers, steps, operations, elements, components, and/or their groups.

It will be understood that while terms “first”, “second”, etc. may be used here for describing various elements, these elements are not to be limited by these terms. These terms are merely used to distinguish one element from another. Accordingly, without departing from the teachings of the examples, a first element discussed below may be referred to as a second element.

It is to be understood that when an element is said to be “connected” or “coupled” to another element, it may be directly connected or coupled to other elements, or there may be intermediate elements. In addition, “connected” or “coupled” as used here may include a wireless connection or wireless coupling. A term “and/or” or an expression “at least one of . . . /at least one” as used here includes any and all combinations of one or more relevant listed items.

Unless otherwise defined, all terms used here (including technical terms and scientific terms) have the same meaning as generally understood by those ordinarily skilled in the art to which the disclosure pertains.

In existing standards, a buffer status report (BSR) mechanism is defined to enable a station to obtain uplink transmission resources. In other words, when the station has data to send, it carries the size of a cached uplink data frame in an A-control field in a data frame or a management frame. The specific definition of a control information subfield in the BSR may be shown in Table 1 below:

TABLE 1
Format of BSR control information subfield

| | | | | B8 B9 | B10 B17 | B18 B25 |
|---|---|---|---|---|---|---|
| | B0 B3 | B4 B5 | B6 B7 | Scaling | Queue Size | Queue Size |
| | ACI Bitmap | Delta TID | ACI Hight | Factor | High | All |
| Bits: | 4 | 2 | 2 | 2 | 8 | 8 |

However, since the BSR or buffer status report poll (BSRP) mechanism, as shown in Table 1, does not satisfy the latency requirements of each service in the IEEE 802.11be standard, and the granularity of the queue size is not clear, the above mechanism of the existing standard cannot satisfy the requirements of a periodic low-latency service.

The disclosure relates to the field of communications, in particular to a communication method and a communication device in wireless communications.

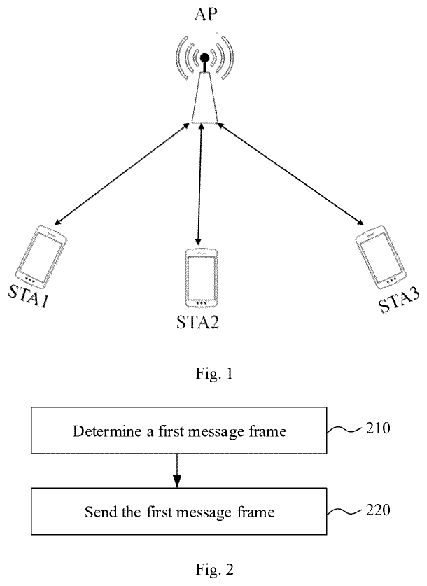

FIG. 1 shows an example schematic diagram of a wireless communication scenario.

In a wireless local area network, a basic service set (BSS) may be composed of an access point (AP) and one or more stations (STAs) that communicate with the AP. The basic service set may be connected to a distribution system (DS) via its AP, and then access another basic service set to compose an extended service set (ESS).

The AP is a wireless switch for a wireless network and is also the core of the wireless network. An AP device may be configured as a wireless base station and mainly configured as a bridge connecting the wireless network to a wired network. With this access point (AP), the wired and wireless networks may be integrated.

As an example, the AP may include a software application and/or a circuit to enable other categories of nodes in the wireless network to communicate with the inside and outside of the wireless network via the AP. For example, the AP may be a terminal or a network device provided with a wireless fidelity (Wi-Fi) chip.

As examples, the station (STA) may include, but is not limited to, a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

Although it is shown in FIG. 1 that one AP communicates with three stations (STA1, STA2, and STA3), this is merely an example, and the examples of the disclosure are not limited to this; for example, the AP and the stations may have any quantity and/or any category.

FIG. 2 shows a flowchart of a communication method according to an example. The communication method shown in FIG. 2 may be performed by a station.

Referring to FIG. 2, a first message frame may be determined in step 210. In the example of the disclosure, there may be a variety of modes to determine the first message frame, for example, the station may generate the first message frame according to at least one of the following: a network condition, a load condition, a hardware capability of a transmitting device, a hardware capability of a receiving device, a service category, or a relevant protocol provision, which is not specifically limited to the example of the disclosure. In the example of the disclosure, the station may further obtain the first message frame from an external device, which is not specifically limited to the example of the disclosure.

According to the example of the disclosure, the first message frame may include information related to a periodic low-latency service, and the information is configured to indicate the periodic low-latency service sent by the station. The periodic low-latency service may refer to a service that needs to be sent periodically with a very low-latency requirement. In the example of the disclosure, examples of the periodic low-latency service may include: transmission of TSN data supported in an IEEE 802.11be standard (which generally requires a latency of less than or equal to 1 ms); transmission of data such as AR/VR (which generally requires a latency between 1 ms and 10 ms); or transmission of data such as interactive video or autonomous driving control (which generally requires a latency between 10 ms and 50 ms). According to the example of the disclosure, the information indicating the periodic low-latency service corresponding to these data to be sent by the station may be carried in the first message frame.

The station may transmit the periodic low-latency service in one transmission opportunity (TXOP) or in a plurality of TXOPs allocated to it by an access point. To satisfy the requirements for low-latency transmission of the data, such as those described above, the content in a BSR is redefined according to the example of the disclosure to identify the size of resources needed to transmit such a service. In the example of the disclosure, the information related to the periodic low-latency service included in the first message frame may include at least one of the following: a size of the periodic low-latency service; a periodic interval of the periodic low-latency service; an access category corresponding to the periodic low-latency service; a traffic identifier corresponding to the periodic low-latency service; time information; or a number of transmissions of the periodic low-latency service. However, this is merely an example; the example of the disclosure is not limited to this, and other information needed to transmit the data may also be included in the first message frame. For example, the information for indicating early termination of the periodic low-latency service may further be included in the first message frame, and in this case, the periodic low-latency service may also be terminated early voluntarily even when the number of transmissions is not met. As another example, the station may carry the information for indicating the early termination of the periodic low-latency service in other frames different from the first message frame, so that it may terminate the periodic low-latency service early voluntarily. In the example of the disclosure, the information for indicating the early termination of the periodic low-latency service may be included in an A-control field or an extended A-control field in the corresponding frame (for example, the first message frame or other frames), or the corresponding frame may contain the information for indicating the early termination of the periodic low-latency service by carrying default information.

According to the example of the disclosure, the information related to the periodic low-latency service (i.e., a BSR) included in the first message frame may be as shown in Table 2 below.

TABLE 2
Information related to periodic low-latency service (BSR)

| | | | | | |
|---|---|---|---|---|---|
| Size | INT | Access | Traffic | Time Info | Number of |
| | | category | identifier | | Transmission |
| | | | (TID) | | |

In the example of the disclosure, the size of the periodic low-latency service may indicate a size of a data volume of the service to be transmitted. The periodic interval corresponding to the periodic low-latency service may be configured to identify a time interval between transmissions of two adjacent periodic low-latency services. The access category corresponding to the periodic low-latency service and the traffic identifier corresponding to the periodic low-latency service may be similar to the ACI bitmap and ATID shown in Table 1 above, respectively, which is not described in detail here for brevity. The time information may be configured to identify a time point at which the periodic low-latency service is sent after sending the first message frame. For example, the time information may indicate the time interval between the time point at which the first message frame is sent completely and the time point at which the periodic low-latency service begins to be sent. The number of transmissions of the periodic low-latency service may be configured to identify a number of continuous transmissions required for the periodic low-latency service; for example, the number of continuous transmissions required for the periodic low-latency service during one or more TXOPs allocated to the station by the access point.

The periodic low-latency service to be sent by the station may include one or more services, and the information related to the periodic low-latency service may include the size, periodic interval, access category, traffic identifier, time information, and a number of transmissions related to each service.

In the example of the disclosure, the information related to the periodic low-latency service (i.e., the BSR) may be included in the first message frame. For example, the information related to the periodic low-latency service (i.e., the BSR) may be included in the A-control field in the first message frame. Specifically, the A-control field may be an early identification field for the periodic low-latency service, i.e., it may be configured to pre-identify the periodic service before sending the periodic service. For example, the information related to the periodic low-latency service (i.e., the BSR) may be included in a MAC frame header part of the first message frame, in which case the first message frame may be a data frame or a management frame.

Continuing to refer to FIG. 2, in step 220, the first message frame may be sent. For example, the station may send the first message frame to the access point, and the access point, after receiving the first message frame, may allocate uplink transmission resources to the station periodically according to the information related to the periodic low-latency service carried in the first message frame.

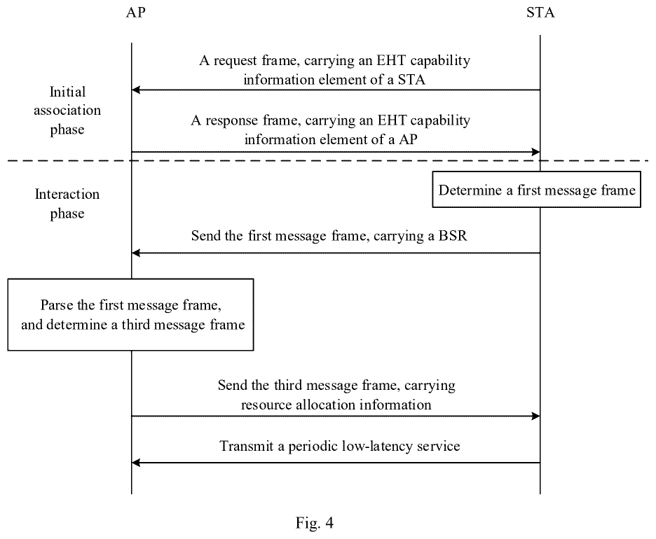

Although merely steps 210 and 220 are shown in FIG. 2, the example of the disclosure is not limited to this. For example, the communication method shown in FIG. 2 may further include sending a second message frame, where the second message frame may include an extreme high throughput (EHT) capability element of the station. The EHT capability element may indicate information about the capability that the station is able to support the (periodic) low-latency service. It is to be understood that the second message frame here is not sent after the first message frame, but may be sent during a process of an association (e.g., an initial association) of the station with the access point; and the first message frame sent in step 220 may be sent during a process of interaction of the station with the access point. This will be described in detail later with reference to FIG. 4.

As an example, the second message frame may be a probe request frame or an association request frame; i.e., the EHT capability element may be encapsulated in the probe request frame or the association request frame. According to the example, a specific definition of the EHT capability element is shown in Table 3 below.

TABLE 3
EHT capability element

| | | Element ID | | |
|---|---|---|---|---|
| Element | Element ID | extension | Extensible | Fragmentable |
| EHT capability | 255 | 61 | Yes | NO |
| element | | | | |

In Table 3, a value of the element ID is 255, and a value of the element ID extension is 61, and they are configured to indicate that a category of the element is the EHT capability element. The Extensible and Fragmentable fields are configured to indicate that the element has attributes of extensibility and non-fragmentable transmission. It will be understood that the values in all parts of Table 3 are merely examples, and the example of the disclosure is not limited to this; other suitable values are also feasible.

According to the example, the EHT capability element described in Table 3 is extensible. Accordingly, although not shown, the EHT capability element may include a capability identification bit, which may be an early identifier for indicating that the station supports the periodic low-latency service in one or more TXOPs and/or supports a low-latency service in one or more TXOPs. As an example, the EHT capability element may include at least one of: a first identifier configured to indicate that the station supports the low-latency service; or a second identifier configured to indicate that the station supports the periodic low-latency service. In the example of the disclosure, the low-latency service may represent a data transmission service that has a strict latency requirement but does not need to be sent periodically, while the periodic low-latency service may represent a data transmission service that has a strict latency requirement and needs to be sent periodically.

Combined with Tables 2 and 3, the communication method shown in FIG. 2 may satisfy the latency requirements of different services and improve system throughput.

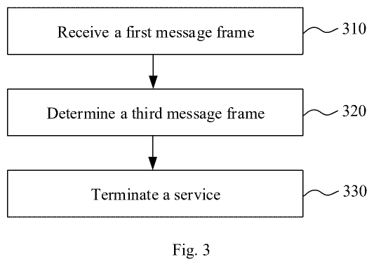

FIG. 3 shows a flowchart of a communication method according to an example. The communication method shown in FIG. 3 may be applied to an access point.

Referring to FIG. 3, a first message frame may be received from a station in step 310. According to the example, the first message frame may include information related to a periodic low-latency service, and the information is configured to indicate the periodic low-latency service sent by the station. The information related to the periodic low-latency service included in the first message frame may be as shown in Table 2 above, and the first message frame may further include the EHT capability element as shown in Table 3 above, the repetitive description of which is omitted here for brevity.

In step 320, a third message frame may be determined based on the information related to the periodic low-latency service, where the third message frame is configured to allocate transmission resources to the station periodically. In the example of the disclosure, the access point may pre-allocate uplink resources of the periodic low-latency service in one or more TXOPs to the station according to a latency requirement of the service (i.e., the information related to the periodic low-latency service) to satisfy the requirements of the low-latency service.

In the example of the disclosure, the access point may be a multi-link device (MLD), i.e., the access point may support transmission of data and information over a plurality of links/connections. For example, the plurality of links may be links on different frequencies, such as 2.4 GHz, 5 GHz, 6 GHz, etc., or the plurality of links on 2.4 GHz with the same or different bandwidths. In this case, the communication method shown in FIG. 3 may further include: the third message frame is determined on other link in response to the access point not being able to allocate transmission resources on a link configured to receive the first message frame. For example, when the first message frame is received on a 2.4 GHz link, but the transmission resources on the 2.4 GHz link cannot satisfy the latency requirements of the service, then the third message frame may be determined on a 5 GHz link and/or a 6 GHz link to allocate the transmission resources to the station. In this example, the third message frame may carry allocated resource information. In some examples, the third message frame may include a link identifier of the other link.

Continuing to refer to FIG. 3, in step 330, the periodic low-latency service may be terminated. In one example, in a case where a number of transmission resources allocated by the access point reaches a number of transmissions of the periodic low-latency service, the periodic low-latency service is terminated. For another example, the first message frame may include information for indicating early termination of the periodic low-latency service. In this case, in step 330, the periodic low-latency service may be terminated in response to the information for indicating the early termination of the periodic low-latency service. In this case, it is possible to disregard whether the number of transmission resources allocated by the access point reaches the number of transmissions of the periodic low-latency service. As a further example, an additional frame (different from the first message frame) may be received from the station; the frame may include the information for indicating the early termination of the periodic low-latency service, and when such information is received, the periodic low-latency service may be terminated early.

Although merely steps 310 to 330 are shown in FIG. 3, the example of the disclosure is not limited to this. For example, the communication method shown in FIG. 3 may further include sending a fourth message frame, where the fourth message frame may include an EHT capability element of the access point. The EHT capability element may indicate information about the capability that the access point is able to support the (periodic) low-latency service. It is to be understood that the fourth message frame here is not sent after the third message frame, but may be sent during a process of an association (e.g., an initial association) of the station with the access point; and the third message frame sent in step 320 may be sent during a process of interaction of the station with the access point. This will be described in detail later with reference to FIG. 4.

As an example, the fourth message frame may be a beacon frame, a probe response frame, or an association response frame; i.e., the EHT capability element may be encapsulated in the beacon frame, the probe response frame, or the association response frame. The fourth message frame may have a format similar to that shown in Table 3, the repetitive description of which is omitted here for brevity. According to the example of the disclosure, the EHT capability element included in the fourth message frame may include a capability identification bit, which is an early identifier for indicating that the access point supports the periodic low-latency service and/or the low-latency service. As an example, the EHT capability element may include at least one of: a third identifier configured to indicate that the access point supports the low-latency service; or a fourth identifier configured to indicate that the access point supports the periodic low-latency service.

The station and the access point are informed of whether the other side supports the (periodic) low-latency service via the second message frame and the fourth message frame during the initial association phase. Further, during the interaction phase, uplink resources are pre-allocated for the periodic low-latency service via the first message frame and the third message frame to satisfy the requirements of the (periodic) low-latency service.

FIG. 4 shows a flowchart of communication between a station and an access point according to an example.

Referring to FIG. 4, during the initial association phase, the STA and the AP are informed of information about each other's capability to support a periodic low-latency service via a request frame (e.g., a probe request frame or an association request frame as examples of a second message frame) and a response frame (e.g., a probe response frame or an association response frame as examples of a fourth message frame). However, the example shown in FIG. 4 is an example, the disclosure is not limited to this, for example, the AP may first broadcast a beacon frame (i.e., the fourth message frame) carrying an EHT capability information element of the AP to the STA, and then the STA may send the association request frame (i.e., the second message frame) carrying an EHT capability information element of the STA to the node AP, thus being informed of each other's capability information during the initial association phase. The EHT capability information element may be as shown in Table 3; its repetitive description is omitted here for brevity.

During the interaction phase, the STA and the AP may pre-allocate uplink resources for the periodic low-latency service via a first message frame and a third message frame, and then perform transmission of the periodic low-latency service in one or more TXOPs. The information related to the periodic low-latency service may be carried in the first message frame, which may be as shown in Table 2, the repetitive description of which is omitted here for brevity.

Although not shown in FIG. 4, the AP may terminate transmission of the periodic low-latency service as shown in step 330 of FIG. 3; its repetitive description is omitted here for brevity.

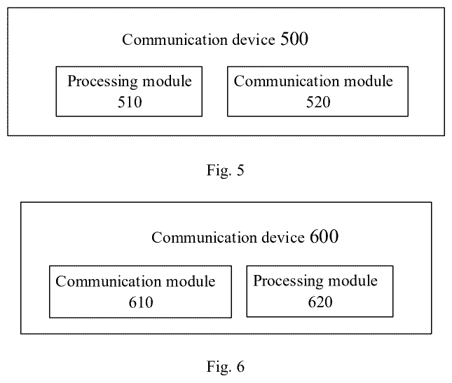

FIG. 5 shows a block diagram of a communication device according to an example of the disclosure. The communication device 500 shown in FIG. 5 may be applied to a station.

Referring to FIG. 5, the communication device 500 may include a processing module 510 and a communication module 520.

The processing module 510 may be configured to determine a first message frame, where the first message frame may include information related to a periodic low-latency service, and the information is configured to indicate the periodic low-latency service sent by the station. The first message frame may be similar to the descriptions in FIG. 2 and Table 2, which are omitted here for brevity. The communication module 520 may be configured to send the first message frame.

According to the example, the processing module 510 may further be configured to control the communication module 520 to send a second message frame, where the second message frame may include an extreme high throughput capability element of the station. The extreme high throughput capability element of the station may be similar to descriptions in FIG. 2 and Table 3, which are omitted here for brevity.

The communication device 500 may perform the communication method described with reference to FIG. 2; the repetitive descriptions are omitted here for brevity. In addition, the communication device 500 shown in FIG. 5 is merely an example, and the example of the disclosure is not limited to this; for example, the communication device 500 may further include other modules, such as a memory module. In addition, individual modules in the communication device 500 may be combined into more complex modules or may be divided into more independent modules to support various functions.

FIG. 6 shows a block diagram of another communication device according to an example of the disclosure. The communication device 600 may be applied to an access point.

Referring to FIG. 6, the communication device 600 may include a communication module 610 and a processing module 620.

The communication module 610 may be configured to receive a first message frame from the station, where the first message frame includes information related to a periodic low-latency service, and the information is configured to indicate the periodic low-latency service sent by a station. The first message frame may be similar to descriptions in FIG. 2 and Table 2, which are omitted here for brevity.

The processing module 620 may be configured to determine a third message frame based on the information related to the periodic low-latency service, where the third message frame is configured to allocate transmission resources to the station periodically. The third message frame may be similar to the descriptions in FIG. 3, which are omitted here for brevity.

According to the example, the processing module 620 may further be configured to terminate the periodic low-latency service in response to the number of transmission resources allocated by the access point reaching the number of transmissions of the periodic low-latency service.

According to the example, in a case where the first message frame or other message frames received by the communication module 610 include information for indicating the early termination of the periodic low-latency service, the processing module 620 may terminate the periodic low-latency service early.

According to the example, the processing module 620 may further be configured to control the communication module 610 to send a fourth message frame, where the fourth message frame includes an extreme high throughput capability element of the access point. The extreme high throughput capability element of the access point may be similar to the descriptions in FIG. 3 and Table 3, which are omitted here for brevity.

The communication device 600 may perform the communication method described with reference to FIG. 3, the repetitive descriptions are omitted here for brevity. In addition, the communication device 600 shown in FIG. 6 is merely an example, and the example of the disclosure is not limited to this. For example, the communication device 600 may further include other modules, such as a memory module. In addition, individual modules in the communication device 600 may be combined into more complex modules or may be divided into more independent modules to support various functions.

The communication method described in FIG. 2 to FIG. 4 and the communication device described in FIG. 5 and FIG. 6 according to the examples of the disclosure can pre-allocate uplink resources of the periodic low-latency service to the station according to the service latency requirements, thus enabling to satisfy the requirements of the (periodic) low-latency service in the IEEE 802.11be standard and to improve the throughput of a system.

Based on the same principles as the method provided in the examples of the disclosure, an example of the disclosure further provides an electronic device including a processor and a memory; where machine-readable instructions (which may also be referred to as “a computer program”) are stored in the memory; and the processor is configured to execute the machine readable instructions to perform the method described with reference to FIG. 2 to FIG. 4.

An example of the disclosure further provides a non-transitory computer-readable storage medium storing a computer program, and the computer program, when executed by a processor, implements the method described with reference to FIG. 2 to FIG. 4.

In the examples, the processor may be configured to implement or execute various exemplary logic boxes, modules, and circuits described in conjunction with the content of the disclosure, for example, a central processing unit (CPU), a general purpose processor, a digital signal processor (DSP), an application specific integrated circuit (ASIC), a field programmable gate array (FPGA), or other programmable logic apparatus, a transistor logic apparatus, a hardware component, or any their combination. The processor may also be a combination that implements a computing function, such as a combination containing one or more microprocessors, a combination of the DSP and the microprocessor, etc.

In the examples, the memory may be, for example, a read-only memory (ROM), a random access memory (RAM), an electrically erasable programmable read-only memory (EEPROM), a compact disc read-only memory (CD-ROM) or other compact disc storage, optical disc storage (including a compact optical disc, a laser disc, an optical disc, a digital versatile disc, a Blu-ray disc, etc.), a disc storage medium or other magnetic storage devices, or any other medium that can be configured to carry or store a program code in a form of an instruction or a data structure and that can be accessed by a computer, but is not limited to this.

It is to be understood that although all the steps in the flowcharts of the accompanying drawings are shown sequentially as indicated by arrows, these steps need not be performed sequentially in the order indicated by the arrows. Unless explicitly stated here, these steps are not executed in a strict order and may be executed in other orders. In addition, at least a part of the steps in the flowcharts of the accompanying drawings may include a plurality of sub-steps or a plurality of phases, which need not be performed to completion at the same moment. Still, they may be performed at different moments, and the order of their execution need not be sequential. Still, they may be performed in turn or alternately with other steps, or at least a part of the sub-steps or phases of other steps.

Although the disclosure has been shown and described with reference to certain examples of the disclosure, it will be understood by those skilled in the art that various changes in form and detail may be made without departing from the scope of the disclosure. Accordingly, the scope of the disclosure is not to be limited to the examples, but rather by the appended claims and their equivalents.

Additional non-limiting embodiments of the disclosure include:

In a first aspect, an example of the disclosure provides a communication method, performed by a station, and the communication method includes:
determining a first message frame, where the first message frame includes information related to a periodic low-latency service, and the information is configured to indicate the periodic low-latency service sent by the station; and
sending the first message frame.

In an example, the communication method may include:
sending a second message frame, where the second message frame includes an extreme high throughput capability element of the station.

In an example, the extreme high throughput capability element includes at least one of the following:
a first identifier configured to indicate that the station supports a low-latency service; or
a second identifier configured to indicate that the station supports the periodic low-latency service.

In an example, the second message frame is sent during a process of an association of the station with an access point.

In an example, the first message frame is sent during a process of interaction of the station with the access point.

In an example, the information related to the periodic low-latency service includes at least one of the following:
a size of the periodic low-latency service;
a periodic interval of the periodic low-latency service;
a category of the access point corresponding to the periodic low-latency service;
a traffic identifier corresponding to the periodic low-latency service;
time information; or
a number of transmissions of the periodic low-latency service.

In an example, the periodic interval is configured to identify a time interval between transmissions of two adjacent periodic low-latency services.

In an example, the time information is configured to identify a time point at which the periodic low-latency service is sent after sending the first message frame.

In an example, the number of transmissions is configured to identify a number of continuous transmissions required for the periodic low-latency service.

In an example, the information related to the periodic low-latency service is included in an A-control field in the first message frame.

In an example, the information related to the periodic low-latency service is included in a MAC frame header part of the first message frame.

In an example, the first message frame further includes information for indicating the early termination of the periodic low-latency service.

In a second aspect, an example of the disclosure provides a communication method, performed by an access point, and the communication method includes:
receiving a first message frame from a station, where the first message frame includes information related to a periodic low-latency service, and the information is configured to indicate the periodic low-latency service sent by the station; and
determining a third message frame based on the information related to the periodic low-latency service, where the third message frame is configured to allocate transmission resources to the station periodically.

In an example, the method may include:
determining the third message frame on other link in response to the access point not being able to allocate the transmission resources on a link configured to receive the first message frame.

In an example, the third message frame includes a link identifier of the other link.

In an example, the method may include:
sending a fourth message frame, where the fourth message frame includes an extreme high throughput capability element of the access point.

In an example, the extreme high throughput capability element includes at least one of the following:
a third identifier configured to indicate that the access point supports a low-latency service; or
a fourth identifier configured to indicate that the access point supports the periodic low-latency service.

In an example, the extreme high throughput capability element of the access point is included in an A-control field in the fourth message frame.

In an example, the information related to the periodic low-latency service includes at least one of the following:
a size of the periodic low-latency service;
a periodic interval of the periodic low-latency service;
a category of the access point corresponding to the periodic low-latency service;
a traffic identifier corresponding to the periodic low-latency service;
time information; or
a number of transmissions of the periodic low-latency service.

In an example, the method may include:
terminating the periodic low-latency service in a case where the number of transmission resources allocated by the access point reaches the number of transmissions of the periodic low-latency service.

In an example, the first message frame further includes information for indicating the early termination of the periodic low-latency service.

In an example, the method may include:
terminating the periodic low-latency service in response to the information for indicating the early termination of the periodic low-latency service.

In a third aspect, an electronic device includes: a memory that stores instructions; one or more processors; where the instructions, when collectively executed by one or more processors, cause the electronic device to perform the method as described in any one of the foregoing technical solutions applied to a station.

In a fourth aspect, a non-transitory computer-readable storage medium stores instructions, where the instructions, when executed by a processor, cause the processor to perform the method as described in any one of the foregoing technical solutions applied to a station.

In a fifth aspect, an electronic device includes: a memory that stores instructions; one or more processors; where the instructions, when collectively executed by one or more processors, cause the electronic device to perform the method as described in any one of the foregoing technical solutions applied to an access point.

In a sixth aspect, a non-transitory computer-readable storage medium stores instructions, where the instructions, when executed by a processor, cause the processor to perform the method as described in any one of the foregoing technical solutions applied to an access point.

As used herein, the term processor may refer to one processor that performs the defined functions or a plurality of processors that collectively perform defined functions, such that the execution of the individual defined functions may be divided amongst such processors.

The technical solutions provided in examples of the disclosure can satisfy the latency requirements of different services and improve system throughput.

1. A communication method, performed by a station, and comprising:
determining a first message frame, wherein the first message frame comprises information related to a periodic low-latency service, and the information related to the periodic low-latency service is configured to indicate the periodic low-latency service sent by the station; and
sending the first message frame.

2. The communication method according to claim 1, further comprising:
determining information for indicating early termination of the periodic low-latency service, wherein the information for indicating the early termination of the periodic low-latency service is carried in an additional message frame different from the first message frame; and
sending the additional message frame.

3. The communication method according to claim 2, wherein the information for indicating the early termination of the periodic low-latency service is configured to indicate that the station does not have any pending traffic for the periodic low-latency service.

4. The communication method according to claim 2, further comprising:
terminating the periodic low-latency service, disregarding whether a number of transmission resources allocated by an access point reaches a number of transmissions of the periodic low-latency service.

5. The communication method according to claim 2, wherein the information for indicating the early termination of the periodic low-latency service is comprised in at least one of the following:
an A-control field in the additional message frame;
an extended A-control field in the additional message frame; or
default information carried in the additional message frame.

6. The communication method according to claim 1, further comprising:
sending a second message frame, wherein the second message frame comprises an extreme high throughput capability element of the station.

7. The communication method according to claim 6, wherein the extreme high throughput capability element comprises at least one of the following:
an identifier configured to indicate that the station supports a low-latency service; or
an identifier configured to indicate that the station supports the periodic low-latency service.

8. The communication method according to claim 6, wherein at least one of the following:
the second message frame is sent during a process of an association of the station with an access point; or
the first message frame is sent during a process of interaction of the station with an access point.

9. The communication method according to claim 1, wherein the information related to the periodic low-latency service comprises at least one of the following:
a size of the periodic low-latency service;
a periodic interval of the periodic low-latency service;
a category of an access point corresponding to the periodic low-latency service;
a traffic identifier corresponding to the periodic low-latency service;
time information; or
a number of transmissions of the periodic low-latency service.

10. The communication method according to claim 9, wherein at least one of the following:
the periodic interval is configured to identify a time interval between transmissions of two adjacent periodic low-latency services;
the time information is configured to identify a time point at which the periodic low-latency service is sent after sending the first message frame; or
the number of transmissions is configured to identify a number of continuous transmissions required for the periodic low-latency service.

11. A communication method, performed by an access point, and comprising:
receiving a first message frame from a station, wherein the first message frame comprises information related to a periodic low-latency service, and the information related to the periodic low-latency service is configured to indicate the periodic low-latency service sent by the station; and
determining a third message frame based on the information related to the periodic low-latency service, wherein the third message frame is configured to allocate transmission resources to the station periodically.

12. The communication method according to claim 11, further comprising:
receiving, from the station, an additional message frame different from the first message frame, wherein the additional message frame carries information for indicating early termination of the periodic low-latency service.

13. The communication method according to claim 12, wherein the information for indicating the early termination of the periodic low-latency service is configured to indicate that the station does not have any pending traffic for the periodic low-latency service.

14. The communication method according to claim 12, further comprising:
terminating the periodic low-latency service, disregarding whether a number of transmission resources allocated by an access point reaches a number of transmissions of the periodic low-latency service.

15. The communication method according to claim 12, wherein the information for indicating the early termination of the periodic low-latency service is comprised in at least one of the following:
an A-control field in the additional message frame;
an extended A-control field in the additional message frame; or
default information carried in the additional message frame.

16. The communication method according to claim 11, further comprising:
determining the third message frame on other link in a case where the access point is unable to allocate the transmission resources on a link configured to receive the first message frame; or
sending a fourth message frame, wherein the fourth message frame comprises an extreme high throughput capability element of the access point.

17. The communication method according to claim 16, wherein the extreme high throughput capability element comprises at least one of the following:
an identifier configured to indicate that the access point supports a low-latency service; or
an identifier configured to indicate that the access point supports the periodic low-latency service.

18. The communication method according to claim 11, wherein the information related to the periodic low-latency service comprises at least one of the following:
a size of the periodic low-latency service;
a periodic interval of the periodic low-latency service;
a category of the access point corresponding to the periodic low-latency service;
a traffic identifier corresponding to the periodic low-latency service;
time information; or
a number of transmissions of the periodic low-latency service.

19. An electronic device, comprising:
a memory that stores instructions; and
one or more processors;
wherein the instructions, when collectively executed by one or more processors, cause the electronic device to:
determine a first message frame, wherein the first message frame comprises information related to a periodic low-latency service, and the information related to the periodic low-latency service is configured to indicate the periodic low-latency service sent by a station; and
send the first message frame.

20. A non-transitory, computer-readable storage medium storing instructions, wherein the instructions, when executed by a processor, cause the processor to perform the communication method according to claim 1.
